(19) United States
(12) Patent Application Publication
(10) Pub. No.: US 2008/0209089 A1
(43) Pub. Date: Aug. 28, 2008

(54) Packet-Based Parallel Interface Protocol For A Serial Buffer Having A Parallel Processor Port

(75) Inventors: Jason Z. Mo, Fremont, CA (US); Stanley Hronik, Sunnyvale, CA (US)

Correspondence Address: BEVER, HOFFMAN & HARMS, LLP, 1432 CONCANNON BLVD, BUILDING G, LIVERMORE, CA, 94550-6006, US

(73) Assignee: Integrated Device Technology, Inc., San Jose, CA (US)

(21) Appl. No.: 11/679,813

(22) Filed: Feb. 27, 2007

(51) Int. Cl. G06F 13/38

(52) U.S. Cl. 710/71

(57) ABSTRACT

A serial buffer is provided having a parallel port configured to couple the serial buffer to a first system via a parallel interface protocol. The serial buffer also includes a serial port configured to couple the serial buffer to a second system via a serial interface protocol and control logic that enables data to be transferred between the parallel port and the serial port in an efficient manner. In one embodiment, the parallel interface protocol is substantially identical to a quad-data rate burst of two (QDRII-B2) interface protocol.

### RELATED APPLICATIONS

The present application is related to the following commonly-owned, co-filed U.S. Patent applications, which are hereby incorporated by reference in their entirety:

U.S. patent application Ser. No. ______ [Attorney Docket No. IDT-2211] “METHOD AND STRUCTURE TO SUPPORT SYSTEM RESOURCE ACCESS OF A SERIAL DEVICE IMPLEMENTING A LITE-WEIGHT PROTOCOL”, by Chi-Lie Wang, Jason Z. Mo and Calvin Nguyen.

U.S. patent application Ser. No. ______ [Attorney Docket No. IDT-2212] “HARDWARE-BASED CONCURRENT DIRECT MEMORY ACCESS (DMA) ENGINES ON SERIAL RAPID INPUT/OUTPUT SRIO INTERFACE”, by Chi-Lie Wang and Bertan Tezcan.

U.S. patent application Ser. No. ______ [Attorney Docket No. IDT-2213] “RAPID INPUT/OUTPUT DOORBELL COALESCING TO MINIMIZE CPU UTILIZATION AND REDUCE SYSTEM INTERRUPT LATENCY”, by Chi-Lie Wang, Kwong Hou (“Ricky”) Mak and Jason Z. Mo.

U.S. patent application Ser. No. ______ [Attorney Docket No. IDT-2214] “MULTI-BUS STRUCTURE FOR OPTIMIZING SYSTEM PERFORMANCE OF A SERIAL BUFFER”, by Steve Juan, Chi-Lie Wang and Ming-Shiung Chen.

### BACKGROUND OF THE INVENTION

1. Field of the Invention

The present invention relates to a serial buffer. More specifically, the present invention relates to a protocol for a parallel processor port of a serial buffer.

2. Related Art

Serial buffers that implement an advanced interface protocol, such as sRIO (serial rapid input/output), or less advanced protocols, such as SerialLite (as specified by FPGA maker Altera) and Aurora (as specified by FPGA maker Xilinx) can support a data input bandwidth of 10 Gigabits/second (Gb/s) and a data output bandwidth of 10 Gb/s.

Serial buffers are typically used in larger systems, which often include a system processor having a parallel port. However, connecting a system processor to a serial buffer typically requires a specialized port hardware and a relatively complicated link layer protocol. These factors undesirably require users to invest significant effort into understanding multiple high speed physical interfaces.

Thus, there is a need to have a parallel processor port for a serial buffer, wherein the parallel processor port has a defined protocol which can physically support data input and output bandwidths of 10 Gb/s, and at the same time, provide an easy to use data link protocol.

No such parallel processor port/protocol is currently known to be available.

### BRIEF DESCRIPTION OF THE DRAWINGS

FIG. 1 is a block diagram of a system, which includes a serial buffer having a parallel port interface in accordance with one embodiment of the present invention.

FIG. 2 is a block diagram illustrating a double word format used to transmit information between a processor and a parallel port interface in accordance with one embodiment of the present invention.

FIG. 3 is a block diagram of a parallel port receive interface in accordance with one embodiment of the present invention.

FIG. 4 is a block diagram of a parallel port transmit interface in accordance with one embodiment of the present invention.

### DETAILED DESCRIPTION

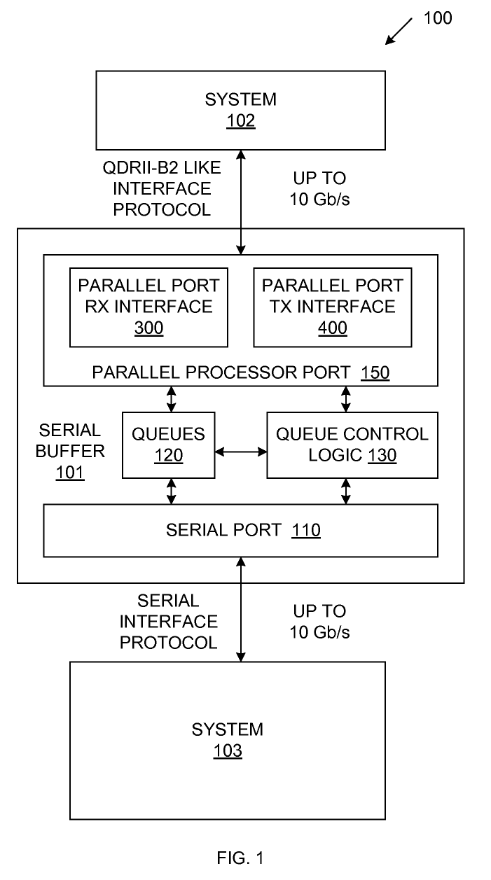

FIG. 1 is a block diagram of a system 100, which includes serial buffer 101 and systems 102-103. System 102 may represent, for example, a processor, memory or field programmable gate array. Similarly, system 103 may represent, for example, a switch or a memory. Transfers between serial buffer 101 and system 103 are performed in accordance with a serial protocol, such as sRIO, SerialLite, or Aurora. In the described examples, transfers between serial buffer 101 and system 103 take place on 32-bit wide data buses at speeds up to 10 Gb/s.

In accordance with one embodiment of the present invention, serial buffer 101 includes parallel processor port 150, a plurality of queues 120 and queue control logic 130 and at least one serial port 110. Parallel processor port 150 (along with queue/queue control logic 120/130) enables communications between system 102 and the serial port 110 of serial buffer 101, such that system 102 can communicate with system 103 through serial buffer 101. Parallel processor port 150 includes parallel port receive interface 300 and parallel port transmit interface 400. The physical layer interface of parallel processor port 150 is adapted from the conventional Quad-Data-Rate Burst of 2 (QDRII-B2) interface. The QDRII-B2 interface is a well known SRAM interface, which provides simple read/write control. As described below, the physical layer interface of parallel processor port 150 incorporates the QDRII-B2 interface with minor modifications. As a result, a user familiar with the QDRII-B2 interface will also be familiar with the physical layer interface of parallel processor port 150.

The conventional QDRII-B2 physical layer interface includes a 36-bit write data bus, a 36-bit read data bus, an address bus, and a control bus. The control bus carries a read enable signal, a write enable signal, a byte write enable signal, and various clock signals. As described in more detail below, adapting the QDRII-B2 interface for use with parallel processor port 150 enables 10 Gb/s data transfer between serial buffer 101 and system processor 102, using a relatively simple protocol.

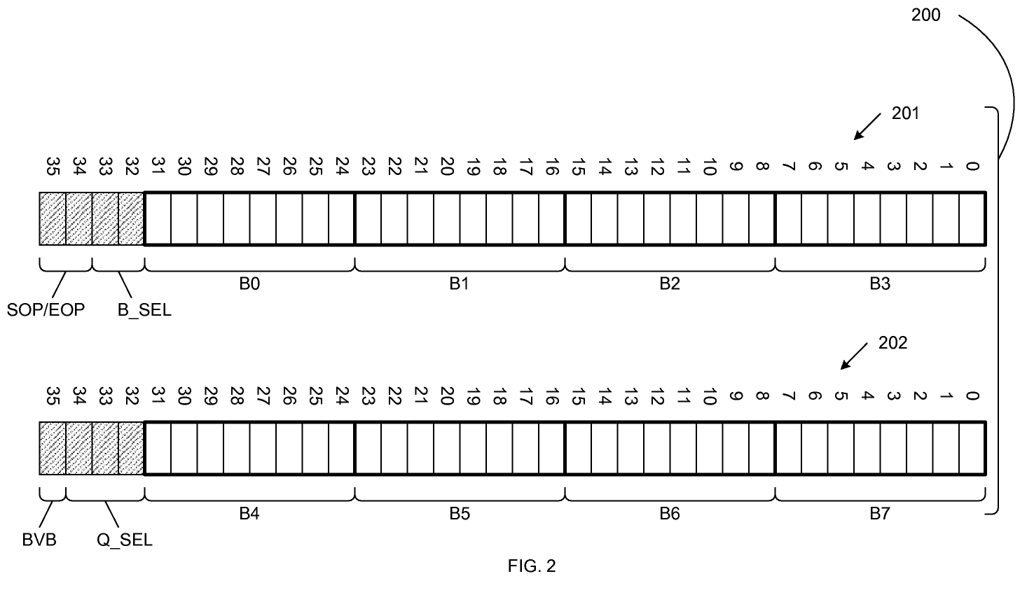

FIG. 2 is a block diagram illustrating a double word format 200 used to transmit information between processor 102 and parallel port 150. This double word format 200 includes two 36-bit words 201-202, which can be transmitted on a conventional 36-bit QDRII-B2 data bus in one clock cycle. The first word 201 includes four data bytes B0, B1, B2 and B3, which are located at bit positions 0-7, 8-15, 16-23 and 24-31, respectively. The first word 201 also includes a start of packet/end of packet identifier (SOP/EOP) at bit positions 34 and 35, and a byte select signal (B_SEL) at bit positions 32 and 33. The second word 202 includes four data bytes B4, B5, B6 and B7, which are located at bit positions 0-7, 8-15, 16-23 and 24-31, respectively. The second word 202 also includes a byte valid signal (BVB) at bit position 35, and a queue select signal (Q_SEL) at bit positions 32-34.

Table 1 below defines the manner in which the SOP/EOP identifier of the first word 201 is encoded in accordance with one embodiment of the present invention.

TABLE 1

| SOP/EOP | MESSAGE |
|---|---|
| 00 | No SOP/EOP (payload only or idle) |
| 01 | Priority Data Packet SOP |
| 10 | Data Packet SOP |
| 11 | Data Packet EOP; or |
| | Data Packet SOP & EOP in the same double word |
| | (i.e., data packet size <= 8 bytes). |

Thus, as illustrated in Table 1, the SOP/EOP identifier can identify the situations where the double word 200 represents the start of a data packet (SOP/EOP=“10”), or the start of a priority data packet (SOP/EOP=“01”). The distinctions between a data packet and a priority data packet are described in more detail below. The SOP/EOP identifier can also indicate that the double word 200 represents neither the start of a packet nor the end of a packet (SOP/EOP=“00”), in which case the double word is payload only, or no valid data is present on the port. Finally, the SOP/EOP identifier can indicate that double word 200 represents the end of a data packet, or that double word 200 represents both the start and the end of a data packet (SOP/EOP=“11”). In the latter case, the data packet has a length of eight bytes or less. Table 1 implies that there is no end of packet (EOP) message associated with a priority data packet. This is because the length of a priority data packet is fixed at two consecutive double words.

Table 2 defines the manner in which the byte valid signal BVB of the second word 202 and the byte select signal B_SEL of the first word 201 are encoded in accordance with one embodiment of the present invention.

TABLE 2

| BVB | B_SEL | MESSAGE |
|---|---|---|
| 0 | 00 | Byte B0 is valid. |
| 0 | 01 | Bytes B0 and B1 are valid. |
| 0 | 10 | Bytes B0, B1 and B2 are valid. |
| 0 | 11 | Bytes B0, B1, B2 and B3 are valid. |
| 1 | 00 | Bytes B0, B1, B2, B3 and B4 are valid. |
| 1 | 01 | Bytes B0, B1, B2, B3, B4 and B5 are valid. |
| 1 | 10 | Bytes B0, B1, B2, B3, B4, B5 and B6 are valid. |
| 1 | 11 | Bytes B0, B1, B2, B3, B4, B5, B6 and B7 are |
| | | valid. |

As illustrated in Table 2, the byte valid signal BVB and the byte select signal B_SEL are used to identify which of bytes B0-B7 are valid within double word 200. If the byte valid signal BVB has a logic zero value, then only bytes B0, B1, B2 and B3 may be valid, as specified by the byte select signal B_SEL. If the byte valid signal BVB has a logic one value, then bytes B0, B1, B2 and B3 are all valid, and bytes B4, B5, B6 and B7 may be valid, as specified by the byte select signal B_SEL.

Table 3 defines the manner in which the queue select signal Q_SEL of the second word 202 is encoded in accordance with one embodiment of the present invention.

TABLE 3

| Q_SEL | MESSAGE |
|---|---|
| 000 | Q0 Selected |
| 001 | Q1 Selected |
| 010 | Q2 Selected |
| 011 | Q3 Selected |
| 100 | Q4 Selected |
| 101 | Q5 Selected |
| 110 | Q6 Selected |
| 111 | Q7 Selected |

As illustrated in Table 3, the queue select signal Q_SEL is used to identify one of up to eight queues within serial buffer 101 to be used to implement the associated transfer.

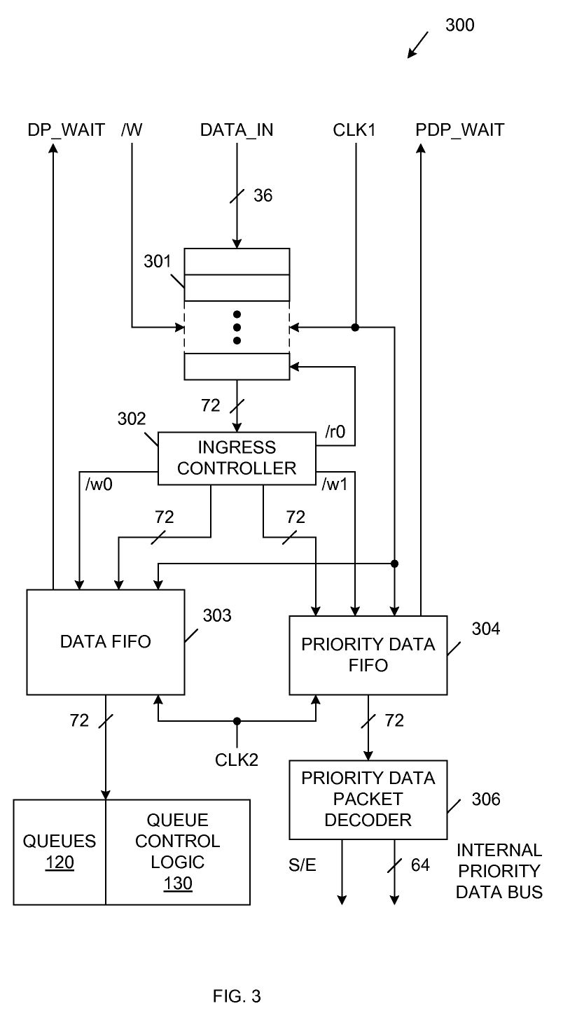

FIG. 3 is a block diagram of parallel port receive interface 300 located within parallel port 150 in accordance with one embodiment of the present invention. Receiver interface 300 includes input register 301, ingress controller 302, data FIFO 303, priority data FIFO 304 and priority packet decoder 306. Input register 301 is configured to receive 72-bit double words from system 102. These 72-bit double words are formed by two 36-bit words having the format defined by FIG. 2 and Tables 1-3. Input register 301 is also configured to receive a write enable signal /W from system 102, and a first system clock signal CLK1 associated with system 102.

When input register 301 detects that system 102 has activated the write enable signal /W, this input register 301 latches the first 36-bit word of the 72-bit double word in response to a rising edge of the first system clock signal CLK1. Input register 301 subsequently latches the second 36-bit word of the 72-bit double word in response to the following falling edge of the system clock signal CLK1. Note that the rising edge of a complementary system clock signal (i.e., CLK1#) can alternately be used to latch the second 36-bit word into input register 301. In this manner, a 72-bit double word can be latched into input register 301 during each cycle of the first system clock signal CLK1. As described above in connection with FIG. 2, each 72-bit double word can include up to 64 (32×2) data bits. Thus, as long as the frequency of the system clock signal CLK1 is greater than or equal to 156.25 MHz, data may be received by input register 301 at a rate of at least 10 Gb/s (i.e., 156.25 MHz×64-bits/cycle).

Note that a conventional QDRII-B2 physical layer interface includes the lines required to transmit the above-described 36-bit words, the write enable signal, and the first system clock signal.

Ingress controller 302 monitors input register 301 to detect the presence of new data. Upon detecting that a new 72-bit double-word has been latched into input register 301, ingress controller 302 activates a local read enable signal /r0, which causes the 72-bit double word to be transmitted from input register 301 to ingress controller 302. Ingress controller 302 decodes the SOP/EOP identifier of the double-word to determine whether the double-word represents the start of a data packet or the start of a priority data packet.

If ingress controller 302 determines that the double-word read from input register 301 represents the start of a priority data packet, (i.e., the SOP/EOP identifier has a value equal to “01”), then ingress controller 302 transmits the double-word to priority data FIFO 304, and activates a local write enable signal /w1, thereby causing the double-word to be written to priority data FIFO 304. Because each priority data packet has a fixed length of two double-words, ingress controller 302 subsequently transmits the next double-word read from input register 301 to priority data FIFO 304 (while continuing to activate the local write enable signal /w1), thereby writing the second double-word of the priority data packet to priority data FIFO 304. Ingress controller 302 ends the transfer of the priority data packet after writing the two consecutive double-words of the priority data packet to priority data FIFO 304 (and does not wait for an end of packet signal associated with the priority data packet). By having fixed length priority packets, there is no need to have an EOP identifier for the priority packets. As described in more detail below, this easily enables priority packets to be nested within longer data packets.

If ingress controller 302 determines that the double-word read from input register 301 represents the start of a data packet (i.e., the SOP/EOP identifier has a value equal to “10” or “11”), then ingress controller 302 transmits the double-word to data FIFO 303, and activates a local write enable signal /w0, thereby causing the double-word to be written to data FIFO 303.

If the ingress controller 302 determines that the SOP/EOP identifier indicates that the received data packet is only one double-word long (i.e., the SOP/EOP identifier is equal to “11”), then ingress controller 302 ends the transfer to data FIFO 303 after the double-word has been written to data FIFO 303.

If the SOP/EOP identifier indicates that the received data packet is more than one double word long (i.e., the SOP/EOP identifier is equal to “10”), then ingress controller 302 continues to transfer subsequently received double words from input register 301 to data FIFO 303, as long as these received double words have an SOP/EOP identifier that does not indicate a start of packet condition or an end of packet condition (i.e., as long as the SOP/EOP identifier has a value of “00”).

When ingress controller 302 detects a double word having an SOP/EOP identifier that identifies the end of the received data packet (i.e., the SOP/EOP identifier is equal to “11”), ingress controller 302 ends the transfer of the received data packet to data FIFO 303 after writing the associated double-word to data FIFO 303.

Note that ingress controller 302 supports nested priority data packets (i.e., priority data packets nested within received data packets). Thus, if ingress controller 302 determines that a priority data packet has been received by input register 301 while ingress controller 302 is in the process of transmitting a data packet to data FIFO 303, then ingress controller 302 will ‘pause’ the transmission of the data packet to data FIFO 303, and immediately transmit the received priority data packet to priority data FIFO 304. This enables the relatively short priority data packets to be processed in an expedited manner by ingress controller 302, without having to wait for an entire data packet (which can be relatively long) to be received and transmitted to data FIFO 303. After the priority data packet has been written to priority data FIFO 304, ingress controller 302 resumes transmission of the interrupted data packet to data FIFO 303.

Data FIFO 303 and priority data FIFO 304 latch the data received from ingress controller 302 in response to the first system clock signal CLK1. In accordance with one embodiment, data received from ingress controller 302 is latched into data FIFO 303 and priority data FIFO 304 in response to the rising (or falling) edges of the first system clock signal CLK1. In another embodiment, the data received from ingress controller 302 is latched into data FIFO 303 and priority data FIFO 304 in response to both the rising and falling edges of the first system clock signal CLK1.

The double-words stored in data FIFO 303 are read out to queue/queue controller logic 120 in response to an internal clock signal CLK2 of the serial buffer 101. Similarly, the double-words stored in priority data FIFO 304 are read out to priority data packet decoder 306 in response to the internal clock signal CLK2. The internal clock signal CLK2 may be synchronous or asynchronous with respect to the first system clock signal CLK1. However, in the described examples, the internal clock signal CLK2 used within the serial buffer 101 is asynchronous with respect to the first system clock signal CLK1.

In accordance with one embodiment, priority data packet encoder 306 processes each double-word received from priority data FIFO 304 in the following manner. Priority data encoder 306 transmits bytes B0-B7 of each double word on a 64-bit internal priority data bus. Priority data packet encoder 306 also activates an SOP/EOP control signal (S/E) to indicate there is valid data on the 64-bit internal priority data bus. In one embodiment, bytes B0-B7 of the priority data packet are encoded to specify read and/or write operations to internal registers of serial buffer 101. These bytes B0-B7 can also be encoded to specify read operations from the queues present in queue/queue controller block 120. One example of encoding bytes B0-B7 is described in more detail in commonly owned, co-filed U.S. patent application Ser. NO. [Attorney Docket No. IDT-2211], which is hereby incorporated by reference in its entirety. In the described embodiment, priority packet decoder 306 ignores the byte select signal B_SEL, the byte valid signal BVB and the queue select signal Q_SEL of the priority data packets received from priority data FIFO 304.

In accordance with one embodiment, queues 120 and queue control logic 130 process the double words received from data FIFO 303 in the following manner. Queue control logic 130 identifies: (1) the start and end of each data packet in response to the SOP/EOP field of each received double-word, in accordance with Table 1, (2) the queue selected to receive bytes B0-B7 of the double-word in response to the queue select signal Q_SEL, in accordance with Table 3, and (3) the valid bytes of the double word in response to the byte valid bit signal BVB and the byte select B_SEL signals, in accordance with Table 2. In response, queue control logic 130 activates the selected queue and byte write enable signals associated with the valid bytes, thereby causing the selected queue to store the valid bytes associated with the double word.

The data packets are subsequently read from queues 120 and provided to serial port transmit interface 111 within serial port 110. Serial port transmit interface 111, in turn, transmits these data packets to system memory 103 in a manner known to those of ordinary skill in the art, using a conventional serial interface protocol, such as sRIO, SerialLite or Aurora.

Data FIFO 303 and priority data FIFO 304 implement flags to indicate when these FIFOs reach a predetermined fullness level (e.g., half full or ¼ full). If data FIFO 303 detects the predetermined fullness level, this FIFO 303 activates a data packet wait control signal (DP_WAIT), which instructs system 102 not to send further data packets. Similarly, if priority data FIFO 304 detects the predetermined fullness level, this FIFO 304 activates a priority data packet wait control signal (PDP_WAIT), which instructs system 102 not to send further priority data packets. When sufficient read operations have been performed to bring the fullness level of data FIFO 303 below the predetermined fullness level, then data FIFO 303 de-activates the data packet wait control signal DP_WAIT, thereby enabling system processor 102 to continue transmitting data packets. Similarly, when sufficient read operations have been performed to bring the fullness level of priority data FIFO 304 below the predetermined fullness level, then priority data FIFO 304 de-activates the priority data packet wait control signal PDP_WAIT, thereby enabling system processor 102 to continue transmitting priority data packets. The predetermined fullness levels of data FIFO 303 and priority data FIFO 304 are selected to ensure that there are no overflow conditions experienced by these FIFOS. Different predetermined fullness levels may be selected for data FIFO 303 and priority data FIFO 304. Note that data FIFO 303 and priority data FIFO 304 will typically have different storage capacities. In one embodiment, data FIFO 303 has a storage capacity sufficient to store four maximum sized data packets (e.g., 4×256 bytes), and priority data FIFO 304 has a storage capacity sufficient to store four or more priority data packets. The DP_WAIT and PDP_WAIT control signals are provided to system 102 on lines that are added to the conventional QDRII-B2 interface.

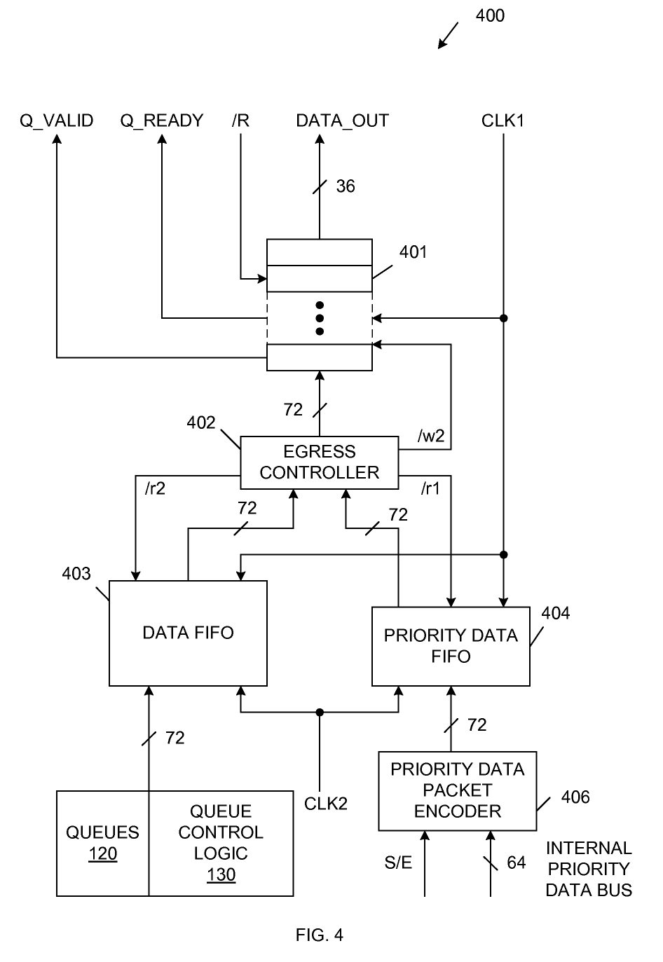

FIG. 4 is a block diagram of parallel port transmit interface 400 located within parallel port 150 in accordance with one embodiment of the present invention. Transmit interface 400 includes output register 401, egress controller 402, data FIFO 403, priority data FIFO 404 and priority data packet encoder 406. Output register 401 is configured to receive a read enable signal /R, which is activated by system 102 during a read operation.

During data packet read operation, serial port buffer 110 receives a data packet from system 103. More specifically, queue control logic 130 receives a plurality of 64-bit data values from serial port buffer 110, and adds the above-described SOP/EOP, BVB, B_SEL and Q_SEL fields to create 72-bit double words that form a corresponding data packet in accordance with FIG. 2 and Tables 1-3. The 72-bit data packet is then stored in the designated queue(s) 120 as decoded by the queue control logic 130.

During a priority data packet read operation, priority data packet encoder 406 retrieves a 64-bit priority data value from the registers of serial buffer 101. The manner in which the 64-bit priority data values are retrieved is described in more detail in commonly owned, co-filed U.S. patent application Ser. No. [Attorney Docket No. IDT-2211]. Priority data packet encoder 406 is also configured to receive 64-bit priority values which are automatically generated within serial buffer 101 when an internal status or error flag status of serial buffer 101 changes. The manner in which these priority values are generated is described in more detail in commonly owned, co-filed U.S. patent application Ser. No. [Attorney Docket No. IDT-2213], which is hereby incorporated by reference in its entirety. Priority data packet encoder 406 adds the above-described SOP/EOP, BVB, B_SEL, Q_SEL fields to the retrieved 64-bit priority data value to create a 72-bit double word that forms a corresponding priority data packet.

Data FIFO 403 is configured to receive each of the read data packets as a plurality of 72-bit double words from queues 120. Similarly, priority data FIFO 404 is configured to receive each read priority data packet as a 72-bit double word from priority data packet encoder 406. The core logic of serial buffer 102 writes the 72-bit double words received from queues 120 and priority packet encoder 406 to data FIFO 403 and priority data FIFO 404, respectively, in response to the internal clock signal CLK2. As a result, the rate of data transfer into data FIFO 403 and priority data FIFO 404 is equal to the rate of data transfer out of data FIFO 303 and priority data FIFO 304 (FIG. 3).

Egress controller 402 monitors data FIFO 403 and priority data FIFO 404 to detect the presence of new double words written to these FIFOs. Egress controller 402 also monitors output register 401 to determine whether this register 401 is full (or has reached a predetermined fullness level). If egress controller 402 detects that a new 72-bit double-word has been latched into priority data FIFO 404 and determines that output register 401 is not full, then egress controller 402 activates a local read enable signal /r1, which causes the 72-bit double word (i.e., priority data packet) to be transmitted from priority data FIFO 404 to egress controller 402. Egress controller 402 then provides the 72-bit priority data packet to output register 401, and activates a local write enable signal /w2, which causes the 72-bit priority data packet to be written to output register 401. Note that egress controller 402 will immediately process any newly detected 72-bit priority data packet in priority data FIFO 404 (as long as output register 401 is not full), regardless of whether data FIFO 403 contains any 72-bit double words associated with a normal data packet. That is, egress controller 402 gives priority to the priority data packets stored in priority data FIFO 404. As a result, priority data packets can be nested within data packets within parallel port transmit interface 400.

If egress controller 402 detects that a new 72-bit double-word has been latched into data FIFO 403, determines that output register 401 is not full, and determines that no priority data packets are stored in priority data FIFO 404, then egress controller 402 activates a local read enable signal /r2, which causes the 72-bit double word to be transmitted from data FIFO 403 to egress controller 402. Egress controller 402 then provides the 72-bit double word to output register 401, and activates a local write enable signal /w2, which causes the 72-bit double word to be written to output register 401.

If output register 401 stores a double-word received from egress controller 402, and this double word has not yet been transmitted to system 102, then output register 401 activates a control signal (Q_READY), which is provided to system 102. The activated Q_READY signal indicates to system 102 that output register 401 is not empty. If output register 401 determines that the read enable signal /R received from system 102 is activated and output register 401 is not empty, then output register 401 activates a Q_VALID control signal with valid data (72 bits in one cycle), which is provided to system 102. The activated Q_VALID signal indicates to system 102 that output register 401 outputs valid read data. Under these conditions, system 102 reads the data stored in output register 401 in response to the first system clock signal CLK1. In accordance with one embodiment, each 72-bit double word stored in output register 401 is transmitted as two 36-bit words having the format specified by FIG. 2. For example, the first 36-bits of each 72-bit double word may be read from output register 401 in response to rising edges of the first system clock signal CLK1, and the last 36 bits of each 72-bit double word may be read from output register 401 in response to corresponding falling edges of the first system clock signal CLK1. As a result, the data transfer rate of output register 401 is the same as the data transfer rate of input register 301. System 102 decodes the 36-bit data words received from output register 401 in accordance with the format specified by FIG. 2 and Tables 1-3.

Note that a conventional QDRII-B2 physical layer interface includes bus lines required to receive the 36-bit data words provided by output register 401, and the bus line required to route the read enable signal /R from system 102 to output register 401. The bus lines required to transmit the Q_READY and Q_VALID control signals from output register 401 to system 102 are not typically found in a conventional QDRII-B2 physical layer interface.

In the foregoing manner, the present invention provides a simple and efficient interface between a serial buffer and the parallel port of an external system.

Although the present invention has been described in connection with several embodiments, it is understood that this invention is not limited to the embodiments disclosed, but is capable of various modifications which would be apparent to one of ordinary skill in the art. Thus, the invention is limited only by the following claims.

We claim:

1. A serial buffer comprising:
a parallel port configured to couple the serial buffer to a first system via a parallel interface protocol;
a serial port configured to couple the serial buffer to a second system via a serial interface protocol; and
control logic configured to transfer data between the parallel port and the serial port.

2. The serial buffer of claim 1, wherein the parallel interface protocol implements a read data bus, a write data bus, a read enable input, a write enable input, a clock input and a clock output.

3. The serial buffer of claim 2, wherein the parallel interface protocol is a subset of a quad-data rate burst of two (QDRII-B2) interface protocol.

4. The serial buffer of claim 2, wherein the parallel interface protocol further comprises a data valid output line for indicating that data appearing on the read data bus is active data.

5. The serial buffer of claim 4, wherein the parallel interface protocol comprises means for activating a signal on the data valid output line one or more clock cycles before active data appears on the read data bus.

6. The serial buffer of claim 1, wherein the control logic comprises a plurality of queues and a queue control logic circuit for controlling data flow through the queues.

7. The serial buffer of claim 1, wherein the parallel port comprises a receive interface that includes an input register configured to store data from the first system in response to a first clock signal associated with the first system.

8. The serial buffer of claim 7, wherein the receive interface further comprises an ingress controller configured to receive data from the input register, and determine whether the received data is associated with a data packet or a priority data packet.

9. The serial buffer of claim 7, wherein the receive interface further comprises an ingress controller configured to receive data from the input register, and identify contents of the received data in response to one or more bits of the received data.

10. The serial buffer of claim 9, wherein the ingress controller is configured to identify different types of packets in response to the one or more bits of the received data.

11. The serial buffer of claim 9, wherein the ingress controller is configured to identify packet boundaries in response to the one or more bits of the received data.

12. The serial buffer of claim 11, wherein the receive interface further comprises a data memory coupled to the ingress controller, wherein the data memory is configured to retain packet boundaries associated with the received data, whereby data received by the data memory on the parallel port and data transmitted from the data memory on the serial port contain identical delimiting information.

13. The serial buffer of claim 12, further comprising means for appending packet headers consistent with the serial interface protocol to data transmitted from the data memory on the serial port.

14. The serial buffer of claim 9, wherein the ingress controller is configured to identify a destination of the received data in response to the one or more bits of the received data.

15. The serial buffer of claim 8, wherein the receive interface further comprises:
a data memory coupled to the ingress controller, wherein the ingress controller is configured to write data associated with data packets to the data memory in response to the first clock signal; and
a priority data memory coupled to the ingress controller, wherein the ingress controller is configured to write data associated with priority data packets to the priority data memory in response to the first clock signal.

16. The serial buffer of claim 15, further comprising a priority data packet decoder coupled to receive the data associated with priority data packets from the priority data memory, and in response, generate instructions for accessing internal registers of the serial buffer.

17. The serial buffer of claim 15, wherein the control logic comprises a plurality of queues and queue control logic configured to transfer data from the data memory to the serial port.

18. The serial buffer of claim 15, wherein the data memory and the priority data memory are configured to read data in response to an internal clock signal of the serial buffer.

19. The serial buffer of claim 15, wherein the data memory is configured to activate a first control signal to indicate that the data memory has reached a predetermined fullness level.

20. The serial buffer of claim 15, wherein the priority data memory is configured to activate a second control signal to indicate that the priority data memory has reached a predetermined fullness level.

21. The serial buffer of claim 15, wherein the data memory is configured to provide a first status signal to the first system on the parallel port, and the priority data memory is configured to provide a second status signal to the first system on the parallel port, wherein the first system is configured to control the flow of data packets and priority data packets on the parallel port in response to the first and second status signals, thereby optimizing the parallel port interface and the performance of the first system.

22. The serial buffer of claim 8, wherein the priority data packets have a fixed length.

23. The serial buffer of claim 8, wherein the ingress controller is configured to process the priority data packets with a higher priority than the data packets, whereby the processing of priority data packets may be nested within the processing of data packets.

24. The serial buffer of claim 1, wherein the parallel port comprises a transmit interface that includes:
an output register; and
an egress controller configured to transmit data packets provided from the serial port and register data provided from internal registers of the serial buffer to the output register.

25. The serial buffer of claim 24, wherein the output register is configured to transmit the data packets and the register data to the first system in response to the first clock signal.

26. The serial buffer of claim 25, wherein the transmit interface further includes:
a data memory configured to transfer the data packets from the serial port to the egress controller; and
a priority data memory configured to transfer the register data from the internal registers to the egress controller.

27. The serial buffer of claim 26, wherein the egress controller is configured to transmit the register data with a higher priority than the data packets.

28. The serial buffer of claim 27, wherein the output register is configured to activate a first control signal to indicate that the output register contains data that has not been transmitted to the first system.

29. The serial buffer of claim 28, wherein the output register is configured to activate a second control signal to indicate that the output register contains data that has not been transmitted to the first system and the first system is requesting data on the parallel port.

30. The serial buffer of claim 24, wherein the register data is transmitted in priority data packets having a fixed length.

31. The serial buffer of claim 30, wherein the egress controller is configured to process the priority data packets with a higher priority than the data packets, whereby the processing of the priority data packets may be nested within the processing of the data packets.

32. The serial buffer of claim 1, wherein the parallel port comprises a transmit interface that includes:
an output register configured to provide data to the first system on the parallel port; and
an egress controller configured to transmit data packets and priority data packets to the output register, wherein the data packets include data received on the serial port, and the priority data packets include data received from internal registers of the serial buffer,
wherein the data provided by the output register to the first system on the parallel port includes bits dedicated to identifying the contents of the data.

33. The serial buffer of claim 32, wherein the data provided by the output register to the first system on the parallel port includes bits dedicated to identifying the data as a data packet or a priority data packet.

34. The serial buffer of claim 32, wherein the data provided by the output register to the first system on the parallel port includes bits dedicated to identifying packet boundaries of the data.

35. The serial buffer of claim 32, wherein the data provided by the output register to the first system on the parallel port includes bits dedicated to identifying a queue that provided the data to the egress controller within the serial buffer.

36. The serial buffer of claim 32, wherein the data provided by the output register to the first system on the parallel port includes bits dedicated to indicating whether the data is a response to a read request of the first system, or an indication that a trigger event has occurred within the serial buffer.

37. The serial buffer of claim 32, wherein the priority data packets include data identifying an internal status or error flags of the serial buffer.
